(19) United States
(12) Patent Application Publication
(10) Pub. No.: US 2018/0274187 A1
(43) Pub. Date: Sep. 27, 2018

(54) APPARATUS THAT PROVIDES ENERGY INDEPENDENCE THROUGH ISLANDING FROM THE GRID VIA GREEN, SUSTAINABLE, RENEWABLE ENERGY SOURCES FOR COMMERCIAL/RESIDENTIAL STRUCTURES ON ELEVATED SPANS

(71) Applicant: Jaime Miguel Bardia, Greenwich, CT (US)

(72) Inventor: Jaime Miguel Bardia, Greenwich, CT (US)

(21) Appl. No.: 15/933,041

(22) Filed: Mar. 22, 2018

Related U.S. Application Data
(60) Provisional application No. 62/477,378, filed on Mar. 27, 2017.

(51) Int. Cl. E01D 18/00; H02J 3/38; H02S 20/22; E04H 1/00; E04H 3/00; B61B 13/04; E04B 1/32; E04B 1/00; E04B 2/88; E04H 6/08; G09F 7/00; E01C 1/00; B60M 7/00; F03D 9/00

(52) U.S. Cl. CPC E01D 18/00; F05B 2220/708; H02S 20/22; E04H 1/00; E04H 3/00; B61B 13/04; E04B 1/32; E04B 1/0007; E04B 2/88; E04H 6/08; G09F 7/00; E01C 1/002; B60M 7/00; F03D 9/007; F24J 3/08; H02J 2003/388; H02J 3/382

(57) ABSTRACT

Repurpose decommissioned elevated highways, decommissioned elevated railways, decommissioned bridges, viaducts, and causeways and or new construction of elevated spans by making provision for providing energy from non-fossil fuel sources, such as solar, wind, geothermal and/or hydrothermal, to provide the energy needs of habitable structures and facilities built upon such decommissioned elevated bridges, elevated railways or bridges. Such is done to provide energy independence for such spans that are to be free of fossil-fuel motor vehicle traffic (or trains).

### CROSS-REFERENCE TO RELATED APPLICATIONS

U.S. provisional patent application No. 62/477,378 filed Mar. 27, 2017 from which the present application claims the benefit of priority.

### STATEMENT REGARDING FEDERALLY SPONSORED RESEARCH OR DEVELOPMENT

None.

### THE NAMES OF THE PARTIES TO A JOINT RESEARCH AGREEMENT

None.

### Reference to a “Sequence Listing”, a Table, or a Computer Program Listing Appendix Submitted on a Compact Disc and an Incorporation-by-Reference of the Material on the Compact Disc

None.

### Statement Regarding Prior Disclosures by the Inventor or a Joint Inventor

None.

### BACKGROUND OF THE INVENTION

### 1. Field of Endeavor to which the Invention Pertains

The incorporation into new construction of elevated spans and/or repurposing of decommissioned elevated motor vehicle, railroad and other such spans as over-water bridges, over-land highway spans, and viaducts with powering structures thereon from multiple sources of green, sustainable, renewable energy with islanding capacity so as to achieve energy independence as well as the ability to island from the electric grid.

### 2. Description of Information Known to the Inventor, Including References to Specific Documents Related to the Invention, and Specific Problems Involved in the State of Technology that the Invention is Drawn Toward

### Repurposing of an Elevated Span

Over time, the static and dynamic loads that are transmitted to a bridge, viaduct, causeway or elevated roadway by 80,000 pound semitrailers, commercial vehicles and passenger car traffic—or if applicable—286,000 pound railcars weaken the structure thus rendering it economically unfeasible to properly-maintain and thus become classified as unsafe for travel.

When a bridge becomes unsafe for continued use by vehicle traffic, communities often try to devise new uses for them so as to save them from being torn down for scrap. In other words, save the bridge from the scrap heap.

An elevated highway is a controlled-access highway that is raised above grade for its entire length. Elevation is usually constructed as viaducts, typically a long pier bridge. Technically, the entire highway is a single bridge.

An elevated railway (also known as El rail or simply El for short, and, in Europe, as overhead railway) is a rapid transit railway with the tracks above street level on a viaduct or other elevated structure (usually constructed of steel, concrete, or brick). The railway may be standard gauge, narrow gauge, light rail, monorail, or a suspension railway. Elevated railways are usually used in urban areas where there would otherwise be a large number of level crossings. Most of the time, the tracks of elevated railways that run on steel viaducts can be seen from street level.

A bridge is a structure built to span physical obstacles without closing the way underneath such as a body of water, valley, or road, for the purpose of providing passage over the obstacle. There are many different designs that each serve a particular purpose and apply to different situations. Designs of bridges vary depending on the function of the bridge, the nature of the terrain where the bridge is constructed and anchored, the material used to make it, and the funds available to build it.

The original Tappan Zee Bridge, for instance, is a cantilever bridge. The deteriorating structure bears an average of 138,000 vehicles per day, substantially more traffic than its designed capacity. The total length of the bridge and approaches is 16,013 feet (4,881 m). The cantilever span is 1,212 feet (369 m) providing a maximum clearance of 138 feet (42 m) over the water. Such a decommissioned bridge represents an example of a structural span suitable for repurposing in accordance with the invention.

A viaduct is a bridge composed of several small spans for crossing a valley, gorge, marshland or forming a rail flyover. Many viaducts over land connect points of similar height in a landscape, usually by bridging a river valley or other eroded opening in an otherwise flat area. Often such valleys had roads descending either side (with a small bridge over the river, where necessary) that become inadequate for the traffic load, necessitating a viaduct for “through” traffic.

Viaducts are commonly used in many cities that are railroad centers. These viaducts cross the large railroad yards that are needed for freight trains there, and also cross the multi-track railroad lines that are needed for heavy railroad traffic. These viaducts keep highway and city street traffic from having to be continually interrupted by the train traffic. Likewise, some viaducts carry railroads over large valleys, or they carry railroads over cities with many cross-streets and avenues. Such bridges also lend themselves for use by rail traffic, which requires straighter and flatter routes. Some viaducts have more than one deck, such that one deck has vehicular traffic and another deck carries rail traffic. Others were built to span settled areas, crossing over roads beneath.

Islanding refers to the condition in which a distributed generator (DG) continues to power a location even though electrical grid power from the electric utility is no longer present. Islanding can be dangerous to utility workers, who may not realize that a circuit is still powered, and it may prevent automatic re-connection of devices. For that reason, distributed generating systems must detect electric grid failure and immediately disconnect from the electric grid and remain in an islanding mode until the electric grid is restored before reestablishing the grid tie connection.

The common example of islanding is a grid supply line that has solar panels attached to it. In the case of a blackout, the solar panels will continue to deliver power as long as irradiance is sufficient. In this case, the supply line becomes an “island” with power surrounded by a “sea” of unpowered lines. For this reason, solar inverters that are designed to supply power to the grid are generally required to have some sort of automatic anti-islanding circuitry in them.

In intentional islanding, more commonly known as a microgrid, the microgrid disconnects from the grid and forces the distributed generator(s) to power the entire local circuit.

### Vertical Axis Wind Turbines and Solar Photovoltaic Capability

U.S. Patent Application Publication No. 2017/0096985 by the present invention is entitled “Method and apparatus that generate electricity from a wind turbine equipped with self-cleaning photovoltaic panels” is incorporated in its entirety by reference herein. It discloses an apparatus that can optimize wind power without compromising solar photovoltaic power collection by doing so and yet provide self-cleaning of the solar photovoltaic panels of the collector. The panels rotate in unison with rotation of the wind turbine airfoils and arranged in a planar region that is substantially transverse to a circumferential region in which the airfoils rotate beneath the solar photovoltaic collector.

U.S. Pat. No. 9,528,498 by the present inventor is entitled “On or off grid vertical axis wind turbine and self contained rapid deployment autonomous battlefield robot recharging and forward operating base horizontal axis wind turbine” is incorporated in its entirety by reference herein. It discloses a vertical axis wind turbine and horizontal wind turbine each with a rotary airfoil assembly that has helical swept airfoils whose free ends each have a spoiler. The vertical axis wind turbine has permanent magnet discs for levitating static weight of an entirety of the rotary airfoil assembly via magnetic repulsion. There is a hub or affixing the permanent magnet discs within a frame structure in a manner that counteracts both a coefficient of friction (“COF”) associated with rotation of the rotary airfoil assembly and ensuing bearing wear imparted from the rotary airfoil assembly. The horizontal axis wind turbine has collapsible telescoping towers.

### Hydropower—Hydroelectric Generator Turbines

U.S. provisional patent application No. 62/477,378, whose contents are incorporated herein by reference, provides a discussion pertaining to hydroelectricity.

Run-of-river hydroelectricity (ROR) or run-of-the-river hydroelectricity is a type of hydroelectric generation plant whereby little or no water storage is provided. U.S. Pat. No. 8,820,063, whose contents are incorporated herein by reference, discusses conventional run-of-the-river generation plants. U.S. Pat. No. 8,591,178, whose content is incorporated by reference, discloses a very low head packaged small hydro station.

### Geothermal Power

According to the online website of the union of concerned scientists at www.ucsusa.org/clean_energy/our-energy-choices/renewable-energy/:

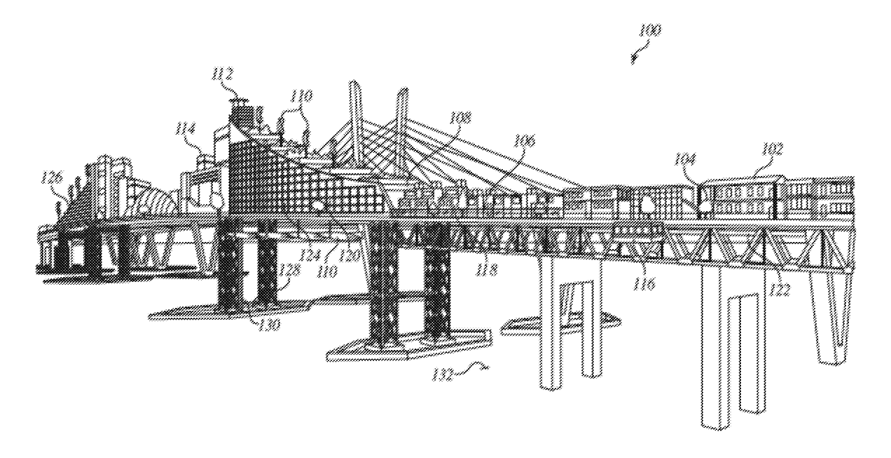

How geothermal energy is captured
Geothermal springs for power plants. Currently, the most common way of capturing the energy from geothermal sources is to tap into naturally occurring “hydrothermal convection” systems, where cooler water seeps into Earth's crust, is heated up, and then rises to the surface. Once this heated water is forced to the surface, it is a relatively simple matter to capture that steam and use it to drive electric generators. Geothermal power plants drill their own holes into the rock to more effectively capture the steam.
There are three basic designs for geothermal power plants, all of which pull hot water and steam from the ground, use it, and then return it as warm water to prolong the life of the heat source. In the simplest design, known as dry steam, the steam goes directly through the turbine, then into a condenser where the steam is condensed into water. In a second approach, very hot water is depressurized or “flashed” into steam which can then be used to drive the turbine.
The choice of which design to use is determined by the resource. If the water comes out of the well as steam, it can be used directly, as in the first design. If it is hot water of a high enough temperature, a flash system can be used; otherwise it must go through a heat exchanger. Since there are more hot water resources than pure steam or high-temperature water sources, there is more growth potential in the binary cycle, heat exchanger design.
In the third approach, called a binary cycle system, the hot water is passed through a heat exchanger, where it heats a second liquid—such as isobutane—in a closed loop. Isobutane boils at a lower temperature than water, so it is more easily converted into steam to run the turbine. These three systems are shown in the diagrams [of FIGS. 1D, 1E and 1F, respectively of U.S. provisional patent application No. 62/477,378].

### Solar Photovoltaic Integrated in Glass Walls and Windows

According to the Solar Window Technologies Inc. website at www.solarwindow.com:
SolarWindow™ achieves payback within one year, according to first-ever independently validated financial modeling results. To produce the equivalent amount of energy with conventional solar systems would require at least 5-11 years for payback and at least 10-12 acres of valuable urban land. Unlike the many acres of expensive downtown real estate required for solar array fields, SolarWindow™ systems can be installed on the readily-available vast window glass surfaces on tall towers and skyscrapers. Engineered to outperform rooftop solar by 50-fold. Works in natural, shaded, and even indoor light.
SolarWindow™ can be applied to all four sides of tall towers, generating electricity using natural, shaded, and even artificial light. Conventional solar simply does not work in shaded areas or perform under artificial light.

### BRIEF SUMMARY OF THE INVENTION

One aspect of the present invention is to incorporate renewable power structures into new construction of elevated spans and/or into repurposed, decommissioned elevated highways, decommissioned elevated railways, decommissioned bridges, viaducts, and causeways. The power structures provide energy from non-fossil fuel sources, such as solar, wind, geothermal and/or hydrothermal to provide the energy needs of habitable structures and facilities built upon such decommissioned elevated bridges, elevated railways or bridges. The intent is to provide energy independence for such spans that are to be free of fossil-fuel motor vehicle traffic (or trains). Such repurposing preferably entails the following:
Create new “water front” living spaces—Full river view glass basement homes
Retractable glass-clamshell encased climate-controlled large format moving sidewalks capable of accommodating strollers and wheelchairs
Generate new real-estate and sales tax revenue for host community
Create virtual “Carbon Emission Free” living spaces that are powered by 100% renewable energy sources, including hydrothermal cooling and heating that use hydro (river flow driven) turbines, solar panels both stationary and or self-cleaning, horizontally mounted vertical axis wind turbines below and above the elevated span, geothermal cooling and heating, building-applied photovoltaic (BAPV) glazing materials
Off-Grid capable micro grid independence via renewable energy production, storage and distribution
Under bridge full river-view (glass walls and floors) homes and commercial spaces
ICE-free (internal-combustion-engine) with only bicycles and electric vehicles allowed on streets; ICE autos to park in discrete enclosed garages at shoreline anchor points with provisions for low income housing. From there, moving sidewalk and or electric shuttles will transport residents and visitors to destinations within the development. No vehicular thru traffic permitted on bridge
Centralized recycling, refuse collection and composting facilities

### BRIEF DESCRIPTION OF THE SEVERAL VIEWS OF THE DRAWING

For a better understanding of the present invention, reference is made to the following description and accompanying drawings, while the scope of the invention is set forth in the appended claims.

The drawing is an isometric layout of the Tappan Zee bridge that is repurposed in accordance with the invention as an energy-independent and thru traffic-free community.

### DETAILED DESCRIPTION OF THE INVENTION

Turning to the drawing, an energy independent traffic-free community is shown. It encompasses the concept for repurposing decommissioned bridges 100, such as the Tappan Zee bridge that is to be decommissioned, and applies equally for repurposing decommissioned elevated motor vehicle, railroad and other such spans (highways or railways) as over-water bridges, over-land highway spans, and viaducts. Over-land spans would use geothermal rather than hydrothermal HVAC wells and there would be no water-current-driven generators in the case of such over-land spans.

The energy independent traffic-free community may accommodate conventional residences, structures and facilities. These include luxury estates 102, greenways 104, glass clamshell enclosed and climate controlled moving sidewalks 106, retail and restaurant space 108 within the center span superstructure, wind turbines 110, energy towers 112 in that all glass walls incorporate solar photovoltaic collector capability and may be equipped with a helipad 114 on its roof, trams 116, condominiums 118, apartments 120, an under bridge view glass basements or observation decks 122 for homes and restaurants, a community center 124 with tennis courts and health clubs, vertical farming and green rooftops 126, hydrothermal heating and cooling 128, geothermal heating and cooling 130, and river current driven hydro turbines 132

The wind turbines may be vertical axis wind turbines arranged to extend to an elevation higher than that of apartments on the span. The vertical axis wind turbines may be equipped with solar voltaic capability, such as that of U.S. Patent Application Publication No. 2017/0096985. If there is dry land, rather than river water, underneath the elevated, then a geothermal power plant may be positioned accordingly in the manner of any of FIG. 1E, 1F, or 1G of provisional patent application No. 62/477,378, whose contents are incorporated by reference, to generate electricity upon being driven by underground geothermal sources. If there is river water, rather than dry land, underneath the elevated, then a hydroelectric power plant with hydro turbines may be positioned accordingly to generate electricity by being driven by the river water current and preferably using hydrothermal HVAC wells in the manner of FIG. 1A, 1B or 1C of provisional patent application No. 62/477,378, whose contents are incorporated by reference, or run-of-river hydroelectricity (ROR) or a very low head packaged small hydro station such as that of U.S. Pat. No. 8,591,178.

Garages with provisions for low-income housing will be established at the entry points to the bridge since the facilities, residences and structures on the bridge are fossil fuel vehicle traffic free. Preferably, power generated from the solar photovoltaic glass walls, wind turbines and river current driven hydro turbines generate enough energy or power to satisfy the needs of the apartments, condominiums, a community center, trams and facilities on the bridge 100 to render the community energy-independent. Vertical farming may help render the community fresh food independent.

The repurposing of decommissioned elevated traffic/railway/viaduct spans in accordance with the invention provides them with islanding capable renewable energy that is independent, green and sustainable. For new construction of elevated spans, such islanding capable renewable energy that is independent, green and sustainable may be incorporated.

Typically, elevated spans have landings on either side of a region being spanned. The landings may be equipped with a geothermal power installation underneath that transmits the geothermal power within an across the span. The geothermal power may be used to heat or cool the span itself, thereby countering the effects of extreme temperature conditions from the surrounding environment, which may mitigate thermal expansions and contractions of the span that might otherwise arise from the environmental extreme thermal conditions. Even for repurposed elevated spans, a geothermal installation could be retrofitted underneath the elevated span landings in a manner that did not disturb the landings themselves such as in a manner analogous to conventional installing of geothermal underneath paved parking lots of commercial buildings or underground without disturbing landscaping or tree forests.

As a consequence of an energy independent traffic-free community with elevated spans with residences, facilities and structures thereon all with islanding capable renewable energy, benefits result that are discussed in the following.

Freestanding buildings include single homes, condominiums, office space, multi-level living units with all structures built at roadway level and on towers. The buildings may include sustainably-landscaped clusters of stores and boutiques, a community center with a tennis/swim/health club, a helicopter pad (such as at river level) a ferry terminal, marinas, parking decks at entry points that are free of residential streets of parked cars and vehicular traffic, moving sidewalks, glass clamshell-enclosed and temperature-controlled to accommodate baby strollers and wheelchairs. Each building may be equipped with building applied photovoltaic glazing. All will have spectacular river, mountain, city and sky views from their vantage point.

All power needs of the buildings is supplied by solar voltaic panels, vertical wind-powered generator units, underwater turbines powered by river currents, hydrothermal and geothermal heat-pump wells uses river water and land-based wells to satisfy all air-conditioning and much of the heating needs.

There may be glass (or transparent plastic resin) floors for river viewing and a monorail to supplement the moving sidewalks and trams/electric powered shuttles. Further, there may be open space provided for community gardens and farms (such as vertical farming), temperature-controlled wine cellars, theaters/performance space and community room/party room with restaurant kitchen.

Bumper systems are provided to protect all intersections of the bridge pylons with the river. There may be quick-charge stations in garages for electric vehicles. Further, fish-and aquatic shelled mollusk or crustacean-farming at low draft non-navigable shoals near shores may be provided. Waste management may include conventional composting and digesters.

While the foregoing description and drawings represent the preferred embodiments of the present invention, it will be understood that various changes and modifications may be made without departing from the scope of the present invention.

What is claimed is:

1. A method of incorporating islanding capability into an elevated span that is free of motor vehicle through traffic and/or trains traveling across, comprising:
erecting equipment that supplies energy from renewable energy sources to residential structures and/or commercial facilities on the elevated span, the elevated span extending between two landings between which is a region that the elevated span extends over; and
arranging the equipment so that all the energy supplied by the erected equipment is distributed to supply all demand for energy by residential structures and commercial facilities on the elevated span before being distributed elsewhere for consumption, the equipment including a converter of sources of energy into electrical power that are selected from the group consisting of wind power, hydrothermal power, geothermal power, solar photovoltaic and any combination thereof.

2. The method of claim 1, wherein the step of erecting the equipment includes placing certain pieces of the equipment on the elevated span and placing other pieces of the equipment beneath the elevated span.

3. The method of claim 1, further comprising:
erecting commercial facilities on the elevated span in a manner suited to provide associated services;
selecting the associated services from the group consisting of a community center, a tennis club, a health club, a restaurant, and a retail space; and
applying signage to the erected commercial facilities that identifies the selected associated services.

4. The method of claim 1, further comprising:
erecting residential structures on the elevated span in a manner suited to render the residential structures habitable as residences;
selecting the residences from the group consisting of apartments, condominiums and luxury estates; and
arranging greenways neighboring the residential structures on the span.

5. The method of claim 1, further comprising:
erecting residential structures and commercial facilities that consume energy for heating and cooling on the elevated span; and
integrating at least some of the equipment into residential structures and/or commercial facilities.

6. The method of claim 1, further comprising:
moving a tram or monorail train along at least a portion of a length of the elevated span and powering the tram or monorail train with energy supplied by the erected equipment.

7. The method of claim 1, further comprising:
providing a glass clamshell enclosure on the elevated span and providing climate controlled moving sidewalks on the elevated span.

8. The method of claim 1, further comprising:
erecting glass basements beneath the elevated span and attached thereto to provide under span views through the glass of the erected glass basements.

9. The method of claim 5, further comprising:
erecting rooftops for at least some of the residential structures and the commercial facilities that make provision for vertical farming thereupon.

10. The method of claim 5, further comprising:
integrating all glass walls of the residential structures and commercial facilities with photovoltaic capability.

11. An elevated span that spans between landings over a region between the landings and is free of motor vehicle through traffic and/or trains traveling across, comprising:
equipment erected on the elevated span that supplies energy from renewable energy sources to erected residential structures and/or commercial facilities on the elevated span, the equipment being arranged so that all the energy supplied by the erected equipment is distributed to supply all demand for energy by the erected residential structures and commercial facilities before being distributed elsewhere for consumption, the equipment including a converter of sources of energy into electricity that are selected from the group consisting of wind power, hydrothermal power, geothermal power, solar photovoltaic and any combination thereof.

12. The elevated span of claim 11, wherein the erected equipment includes certain pieces of the erected equipment placed on the elevated and other pieces of the erected equipment being placed beneath the elevated.

13. The elevated span of claim 11, wherein the erected commercial facilities are configured in a manner suited to provide associated services, the associated services being selected from the group consisting of a community center, a tennis club, a health club, a restaurant, and a retail space; and
signage applied to the erected commercial facilities that identifies the selected associated services.

14. The elevated span of claim 11, wherein the residential structures are configured in a manner suited to render the residential structures habitable as residences, the residences being selected from the group consisting of apartments, condominiums and luxury estates; and
greenways arranged neighboring the residential structures on the span.

15. The elevated span of claim 11, wherein the erected equipment includes some the erected equipment being integrated into the erected residential structures and/or commercial facilities.

16. The elevated span of claim 11, further comprising:
a tram or monorail train operative to move along at least a portion of a length of the elevated, the erected equipment supplying energy and powering the tram with the energy.

17. The elevated span of claim 11, further comprising:
a glass clamshell enclosure on the elevated span and climate controlled moving sidewalks on the elevated span.

18. The elevated span of claim 11, further comprising:
glass basements erected beneath the span and attached thereto to provide under span views through the glass of the erected glass basements.

19. The elevated span of claim 11, further comprising:
erecting rooftops for at least some of the erected residential structures and the erected commercial facilities that make provision for vertical farming thereupon.

20. The elevated span of claim 11, further comprising:
integrating all glass walls of the residential structures and commercial facilities with photovoltaic capability.
